(19) United States
(12) Patent Application Publication
(10) Pub. No.: US 2003/0192989 A1
(43) Pub. Date: Oct. 16, 2003

(54) Security bulkhead and door construction

(76) Inventors: Frank Owen, Anaheim, CA (US); Peter Petrov, Garden Grove, CA (US); Lloyd Misner, Ontario, CA (US)

Correspondence Address: James E. Brunton, P.O. Box 29000, Suite 860, 700 North Brand Blvd., Glendale, CA, 91029, US

(21) Appl. No.: 10/120,999

(22) Filed: Apr. 10, 2002

(51) Int. Cl. B64D 11/00; B64D 13/00

(52) U.S. Cl. 244/118.5

(57) ABSTRACT

A security barrier made up of a specially constructed bulkhead and a novel security door hingedly mounted within the security bulkhead that provides substantial protection against assault by potential aggressors. The security barrier can be used in various types of sensitive areas, but is particularly well-suited for use in commercial aircraft to separate the passenger compartment from the pilot's compartment and thereby protect the pilots compartment from assault by terrorists and other armed aggressors. The bulkhead is made up of a plurality of sealably interconnected armor protected panels that effectively thwart access to the pilots compartment via the bulkhead. The security door is of a laminate construction that is hingedly mounted within the security bulkhead and uniquely comprises a movable portion movable from a first position to a second position upon the detection of a pressure differential between the passenger compartment and the pilot's compartment. The security door further includes a restraint mechanism for controllably restraining the movement of the movable portion of the door assembly. In one form of the invention, the restraint mechanism includes at least one elongated engagement member, such as an elongated cable, that is carried by the door assembly for engagement with the movable portion of the door assembly

### BACKGROUND OF THE INVENTION

1. Field of the Invention

The present invention relates generally to the construction of security barriers, including security doors and security bulkheads. More particularly the invention concerns the construction of security barriers for use in commercial aircraft.

2. Discussion of the Prior Art

The events of Sep. 11, 2001 have emphasized the need for greater physical security in a number of sensitive areas. One such area is in commercial aircraft where there exists a critical need for protection of the pilot's compartment from assault by armed aggressors. Other sensitive areas vulnerable to attack include nuclear power stations, biological research facilities and the like.

In the past, the entrances to many types of sensitive areas have been protected by the use of a security door of a combination steel and a wood construction sometimes coupled with video cameras and other electronic devices. To a trained aggressor, such security doors are not an effective deterrent. In the case of commercial aircraft, the passageway between the passenger compartment and the pilot's compartment has typically been closed by a conventional hinged door that offers little resistance to a well-trained, well-equipped aggressor. Similarly, the bulkhead that separates the passenger compartment from the pilot's compartment provides little deterrent to terrorists and other aggressors bent on gaining access to the pilot's compartment. There exists, therefore, a critical need for better bulkhead and door constructions to protect entrances to sensitive structures from assault by a skilled and determined aggressors. It is the correction of these past deficiencies to which the thrust of the present invention is directed.

U.S. Pat. No. 5,660,021 issued to Wolgamot et al. discloses an improved security door that is provided in the form of a laminate composite made up of multiple layers. The layers include a first hard layer, a second hard layer, a reinforcing layer disposed between and connecting the first and second hard layers, and a carbonizing layer provided adjacent to the reinforcing layer.

As will become readily apparent from the discussion which follows, the security door of the present invention is of a different construction from that disclosed in Wolgamot et al. and includes a number of novel features absent from the Wolgamot et al. construction.

### SUMMARY OF THE INVENTION

It is an object of the present invention to provide a novel security barrier made out of a specially constructed bulkhead and a novel security door hingedly mounted within the security bulkhead that provides substantial protection against assault by potential aggressors.

Another object of the invention is to provide a bulletproof security bulkhead and security door of the aforementioned character that can be used in various types of sensitive areas, but is particularly well-suited for use in commercial aircraft to separate the passenger compartment from the pilot's compartment and thereby protect the pilots compartment from assault by terrorists and other armed aggressors including preventing injury to the pilot and damage to the cockpit.

Another object of the invention is to provide a novel bulkhead construction of the character described in the preceding paragraphs that is made up of a plurality of sealably interconnected armor protected panels that effectively thwart access to the pilots compartment via the bulkhead. Each of the panels a uniquely constructed as a laminate composite made up of spaced apart non-metallic layers, an intermediate aramid fiber composite layer and a stainless steel outer layer that can be connected to a conventional bulkhead of the character found in commercial aircraft.

Another object of the invention is to provide a security door of the character described in the preceding paragraphs that is of a laminate construction that is hingedly mounted within the security bulkhead and uniquely comprises a removable, convex shaped central egress panel that effectively prevents brute force entry from the passenger compartment, but can quickly and easily be removed by the pilot from the pilot's compartment in case of an emergency to permit egress from the pilot's compartment.

Another object of the invention is to provide a security door as described in the preceding paragraphs that includes novel restraint means that can be operated by the pilot to expeditiously remove the convex shaped central egress panel to permit emergency evacuation.

Another object of the invention is to provide a security door construction that includes sealing means for sealably mounting the security door within a door-frame mounted within the security bulkhead.

Another object of the invention is to provide a security door of the character described in the preceding paragraphs that includes vent means for automatically venting the pilots compartment in the event of the occurrence of a pressure differential between the pilots compartment the passenger compartment.

Another object of the invention is to provide a security door of the class described that includes a viewing port that permits the pilot to look into the passenger compartment following removal of the central door panel.

Another object of the invention is to provide a security door assembly that includes a movable portion movable from a first position to a second position upon the detection of a pressure differential between the passenger compartment and the pilot's compartment.

Another object of the invention is to provide a security door assembly of the character described in the preceding paragraph that includes restraint mechanism for controllably restraining the movement of the movable portion of the door assembly.

Another object of the invention is to provide a security door assembly as described in the preceding paragraphs in which the restraint mechanism includes at least one elongated engagement member, such as an elongated cable, that is carried by the door assembly for engagement with the movable portion of the door assembly.

Another object of the invention is to provide a security door assembly of the aforementioned character that includes an operating mechanism that is carried by said door assembly and is operably associated with the restraint mechanism for releasing the restraint mechanism to permit movement of the movable portion upon the occurrence of a pressure differential between the passenger compartment that and the pilot's compartment.

Another object of the invention is to provide a sensing device that is operably associated with the operating mechanism for generating and transmitting an operating signal to the operating mechanism upon sensing the occurrence of a pressure differential between the passenger compartment and the pilot's compartment.

### BRIEF DESCRIPTION OF THE DRAWINGS

FIG. 1 is a front view of one form of the anti-intrusion apparatus of the invention for use in connection with an aircraft.

FIG. 2 is a greatly enlarged, cross-sectional view taken along lines 2-2 of FIG. 1.

FIG. 3 is a greatly enlarged, cross-sectional view taken along lines 3-3 of FIG. 1

FIG. 4 is an enlarged, side-elevational view of the security door shown in FIG. 1.

FIG. 5 is a top plan view of the security door shown in FIG. 1.

FIG. 6 is a generally perspective view of the access cover component of the security door that enables the aircraft pilot to gain access to an emergency escape mechanism.

FIG. 7 is a generally perspective view of the frangible diaphragm component of the aircraft door component shown in FIG. 1.

FIG. 8 is a generally perspective front view of the aircraft security door component of the apparatus shown in FIG. 1.

FIG. 9 is a generally perspective rear view of the aircraft security door component.

FIG. 10 is a generally perspective, exploded front view of the aircraft security door component of the apparatus of the invention.

FIG. 11 is a generally perspective, exploded rear view of the aircraft security door component of the apparatus of the invention.

FIG. 12 is an enlarged, fragmentary front view of a portion of the apparatus shown in FIG. 1.

FIG. 13 is an enlarged, fragmentary rear view of a portion of the apparatus shown in FIG. 1.

FIG. 14 is an enlarged, cross-sectional view taken along lines 14-14 of FIG. 13.

FIG. 15 is an enlarged, cross-sectional view taken along lines 15-15 of FIG. 13.

FIG. 16 is an enlarged, cross-sectional view taken along lines 16-16 of FIG. 13.

FIG. 17 is an enlarged, cross-sectional view taken along lines 17-17 of FIG. 13.

FIG. 18 is a cross-sectional view similar to FIG. 16, but showing the security door separated from the doorframe.

FIG. 19 is an enlarged, cross-sectional view taken along lines 19-19 of FIG. 13.

FIG. 20 is an enlarged, cross-sectional view taken along lines 20-20 of FIG. 13.

FIG. 21 is an enlarged, cross-sectional view taken along lines 21-21 of FIG. 13.

FIG. 22 is a generally perspective front view of an alternate form of security door assembly of the invention that includes a novel panel assembly that is movable from a first position to a second position upon a depressurization of the passenger compartment.

FIG. 23 is a generally perspective rear view of the alternate form of security door assembly shown in FIG. 22.

FIG. 24 is a fragmentary rear view of a portion of the security door assembly shown in FIG. 23 and partly broken away to shown internal construction.

FIG. 25 is an enlarged cross-sectional view taken along lines 25-25 of FIG. 24.

FIG. 26 is a cross-sectional view similar to FIG. 25, but showing the central panel of the door assembly in an open position.

FIG. 27 is a greatly enlarged cross-sectional view of the area designated as 27 in FIG. 24.

FIG. 28 is a generally perspective front view of an alternate form of security door assembly of the invention that includes an alternate form of vented panel assembly that is movable from a first position to a second position upon a depressurization of the passenger compartment.

FIG. 29 is a generally perspective rear view of the alternate form of security door assembly shown in FIG. 28.

FIG. 30 is a fragmentary rear view of one of the pair of vented panels of the security door assembly shown in FIG. 28 showing the vent panel in an open configuration.

FIG. 31 is a fragmentary front view of one of the pair of vented panels of the security door assembly shown in FIG. 28 showing the vent panel in an open configuration.

FIG. 32 is a foreshortened front view of one of the panels shown in FIG. 28.

FIG. 33 is an enlarged cross-sectional view taken along lines 33-33 of FIG. 32.

FIG. 34 is a foreshortened cross-sectional view taken along lines 34-34 of FIG. 32.

FIG. 35 is a generally perspective front view of yet another form of security door assembly of the invention that includes an alternate form of restraint means, shown here as a door stop assembly that is movable from a first position to a second position upon a depressurization of the passenger compartment.

FIG. 36 is a generally perspective view of the alternate form of restraint means shown in FIG. 28.

FIG. 37 is a greatly enlarged cross-sectional view taken along lines 37-37 FIG. 35.

FIG. 38 is a fragmentary view partly in cross-sectional of the connector means of this latest form of the invention for interconnecting the cable with the operating means of the invention.

FIG. 39 is a generally perspective front view of still another form of security door assembly of the invention that includes another form of restraint means, shown here as a door hinge assembly that is movable from a first position to a second position upon a depressurization of the passenger compartment.

FIG. 40 is a generally perspective view of the alternate form of door hinge restraint means shown in FIG. 39.

FIG. 41 is a greatly enlarged cross-sectional view taken along lines 41-41 of FIG. 39.

FIG. 42 is a fragmentary view partly in cross-sectional of the connector means of this latest form of the invention for interconnecting the cable with the operating means of the invention.

### BRIEF DESCRIPTION OF THE INVENTION

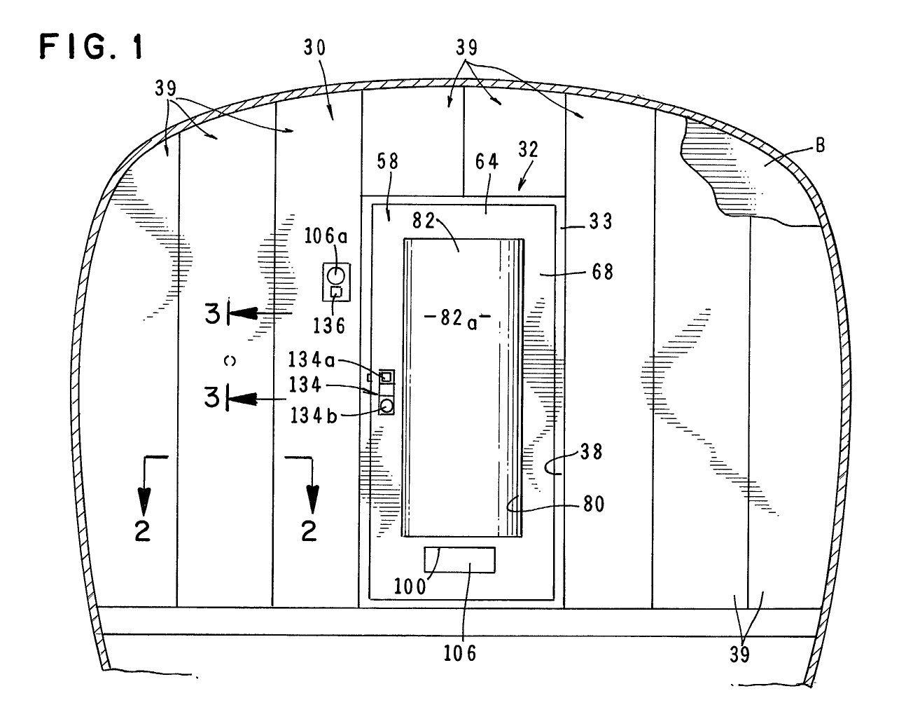

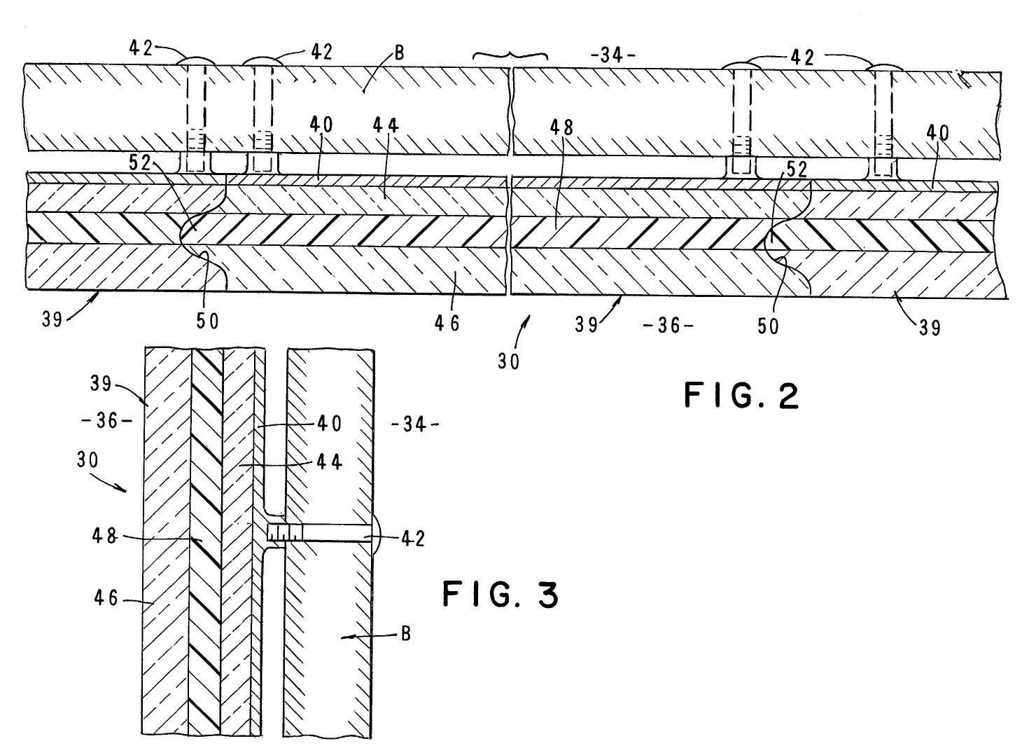

Referring to the drawings and particularly to FIGS. 1, 2 and 3, one form of the security barrier of the invention is there shown for preventing unauthorized access to a first sensitive area, such as the pilot's compartment of a commercial aircraft, from a second adjacent area, such as the passenger compartment of a commercial aircraft. In the form of the invention shown in the drawings, the security barrier includes a security bulkhead 30 and a security door assembly 32 that is hingedly connected to a steel frame 33 that is securely mounted within the bulkhead (FIG. 1). As indicated in FIGS. 2 and 3, the security bulkhead is disposed between the first sensitive area 34, such a pilot's compartment and a second, adjacent area 36, such as a passenger compartment of a commercial airliner. The security bulkhead is provided with an opening 38 that receives the steel frame 33 and the hingedly mounted security door assembly 32, the construction of which will presently be described.

As shown in FIGS. 2 and 3, the security bulkhead 30 of the present form of the invention is uniquely made up of a plurality of sealably interconnected, specially configured segments 39. Each of the segments 39 is of a laminate construction that includes a stainless steel layer 40 that can be suitably interconnected with a conventional wall or bulkhead “B” by a plurality of threaded connectors 42. The security bulkhead 30 also includes a first, nonmetallic composite layer 44, such as a first fiberglass layer that is disposed adjacent steel layer 30, and a second, spaced-apart, nonmetallic layer 46, such as a second fiberglass layer. Non-metallic layers 44 and 46 can be constructed from various materials, but materials such as “S” glass or “S2” glass such as that manufactured by Owens Corning or an equivalent thereof have proven satisfactory for present purposes. Disposed intermediate layers 44 and 46 is a ridged, opaque armor layer generally designated by the numeral 48. Armor layer 48 is preferably constructed of layers of woven ballistic cloth and high-strength tinsel fiber including aramid fibers manufactured and sold by E.I duPont de Nemours Corp. under the name and style KEVLAR (p-phenyleneterephthalamide). or any other combination of high tensile strength fibers including, without limitation, such metal, graphite, metallic glass, or similar fibers, prepared with an oil starch binding impregnated with a resin. In the preferred form of the invention, the ridged armor layer 48 is formed of layers of woven ballistic cloth that are interconnected with the KEVLAR fibers by a resin that sets up with heat and time. The preferred resin hardener, such as isopropyl or polyester resin hardens in approximately one hour at a temperature range of about 250° to about 270° Fahrenheit.

As indicated in FIG. 2, each of the bulkhead segments 39 includes a concave edge portion 50 and a convex edge portion 52 that is configured to sealably mate with a concave edge portion 50. With the construction shown on the drawings, the edges of the segments can be closely fitted together in a tongue and groove fashion to form a gas seal between the interconnected segments. When the segments are interconnected in the manner shown in FIGS. 1 and 2, the completed bulkhead 30 has the general configuration shown in FIG. 1 and is securely of fixed to an existing bulkhead by the plurality of connectors 42. When the completed bulkhead 30 is in place it provides a formidable barrier to aggressors attempting to enter the sensitive area and an unauthorized manner.

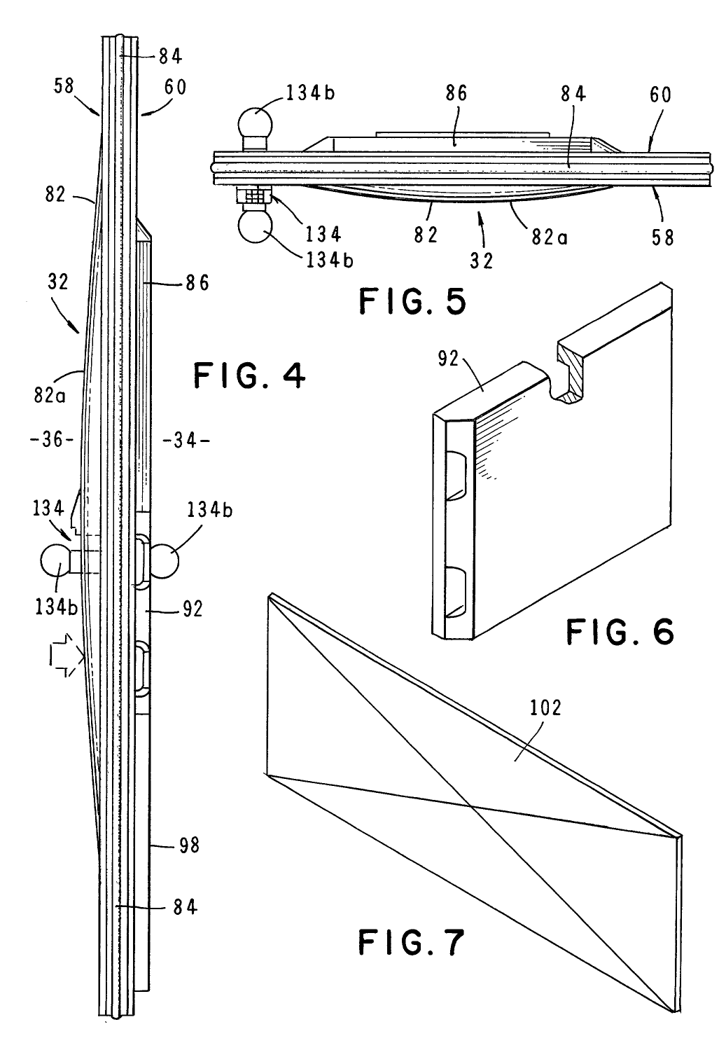

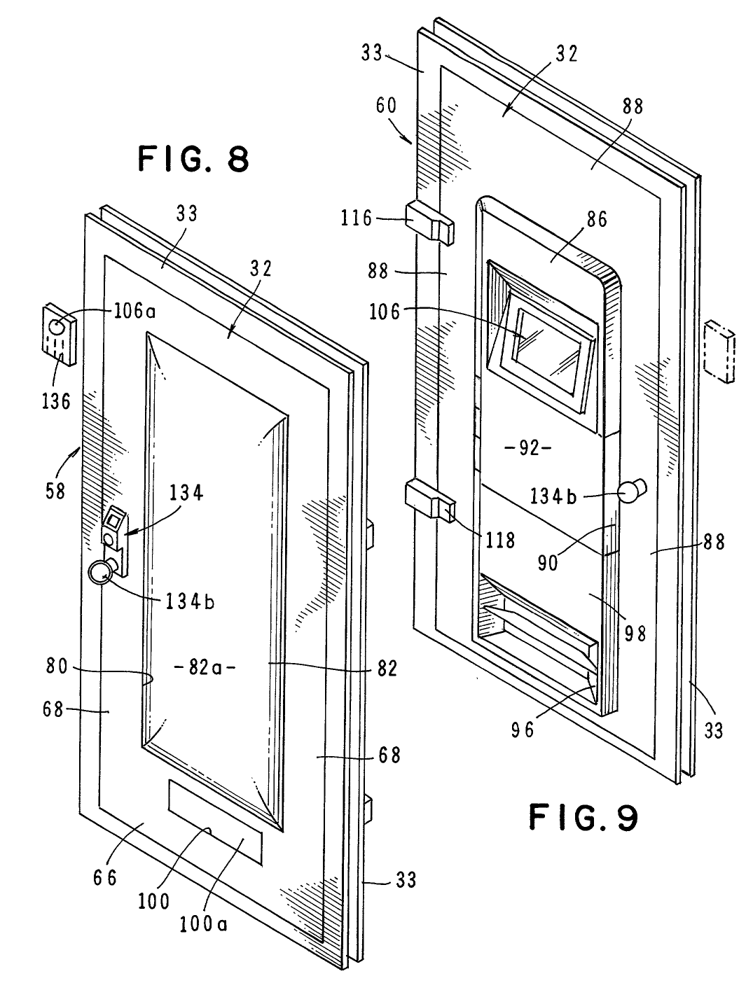

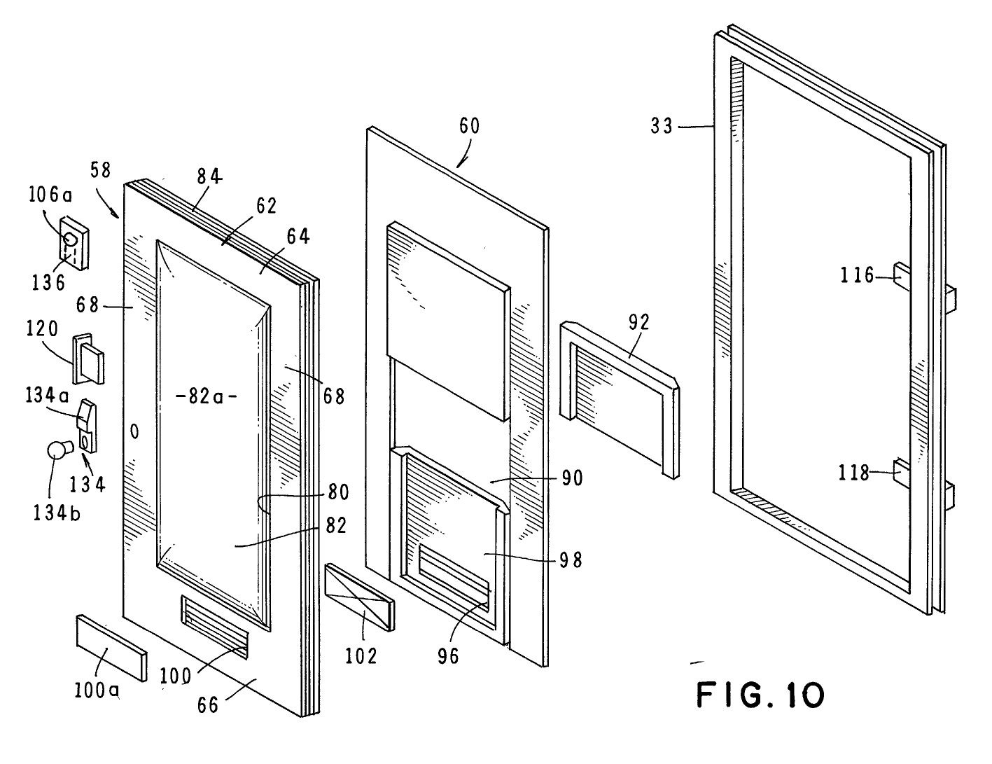

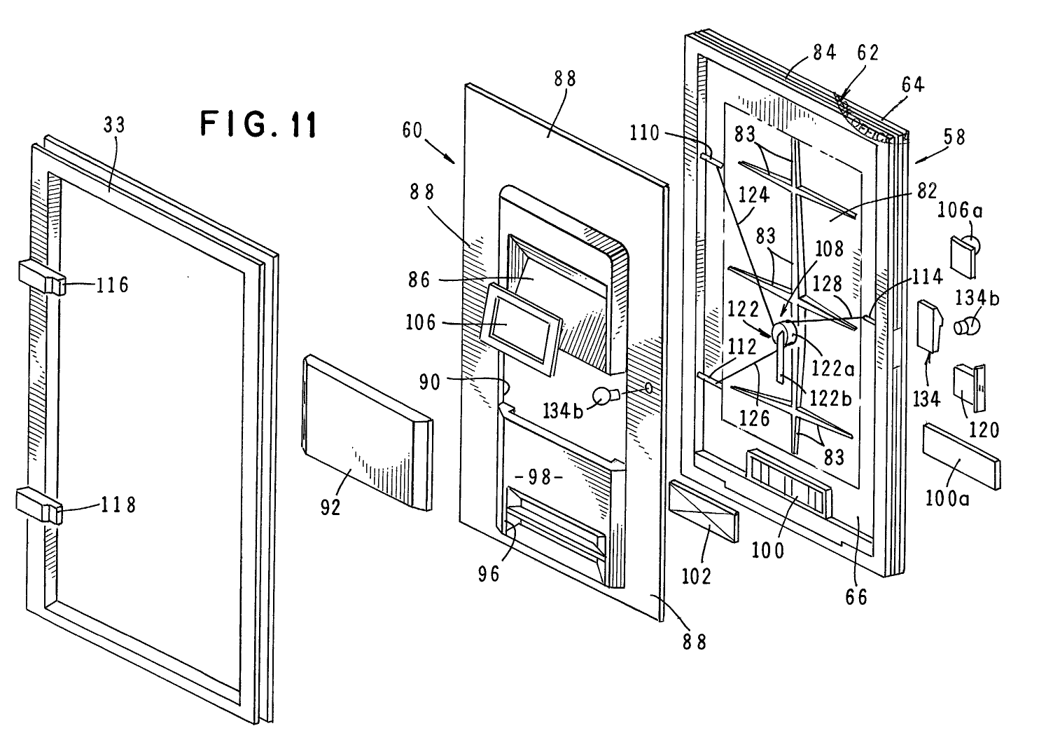

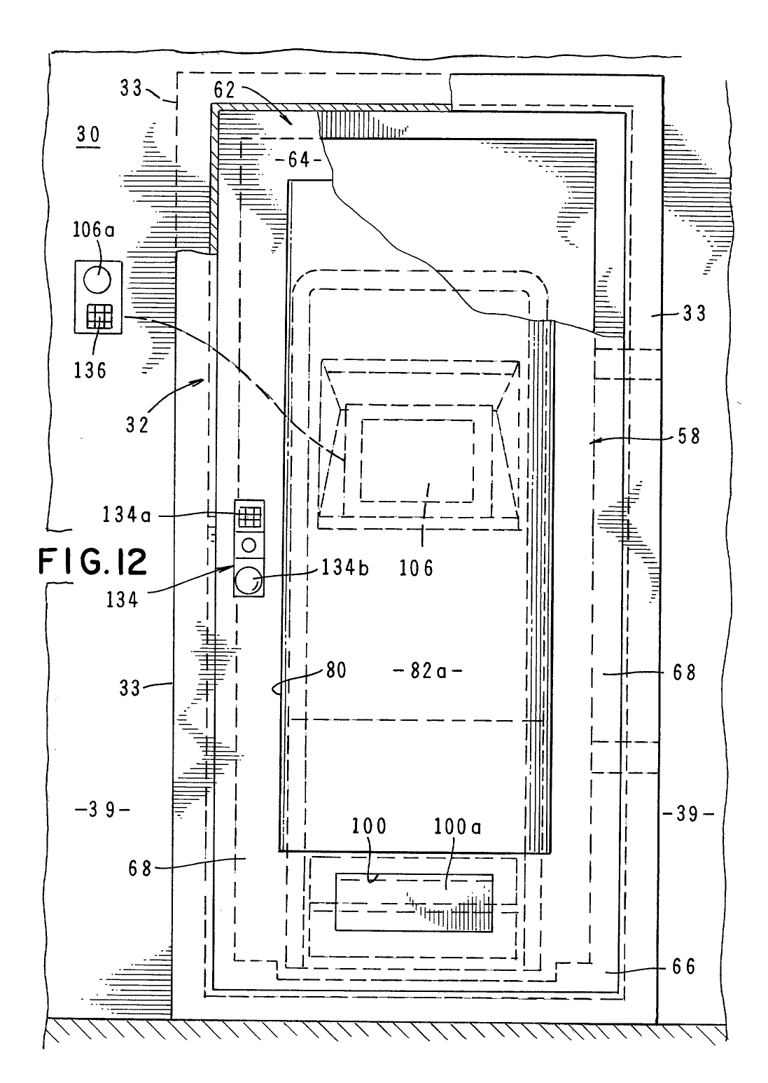

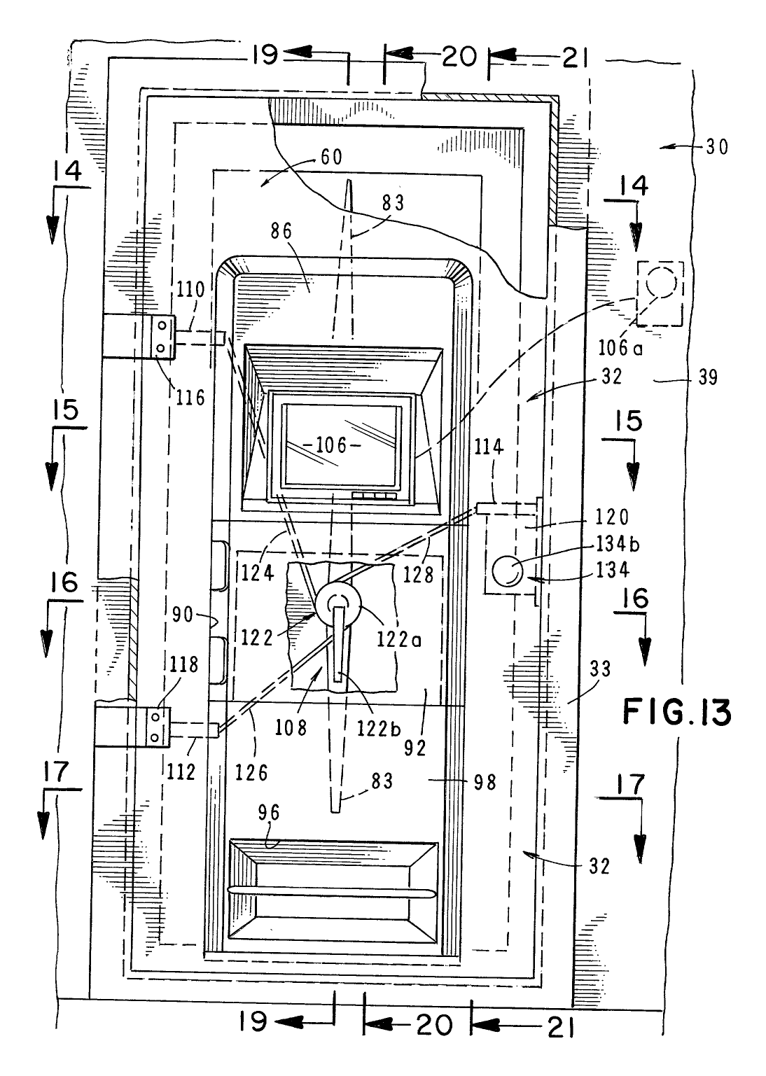

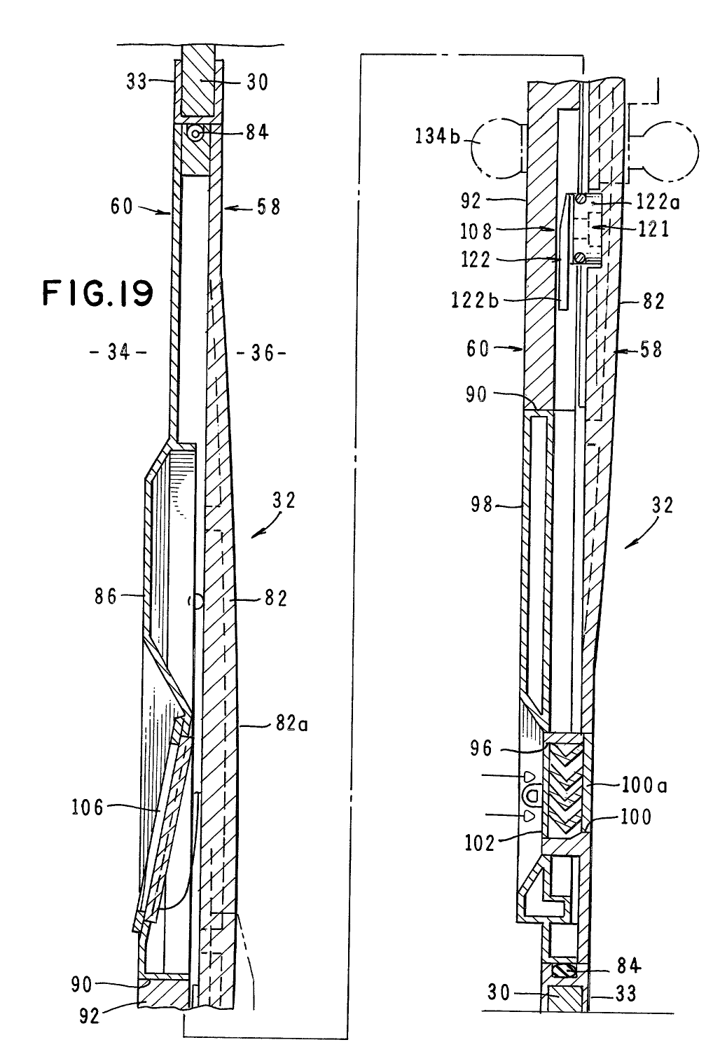

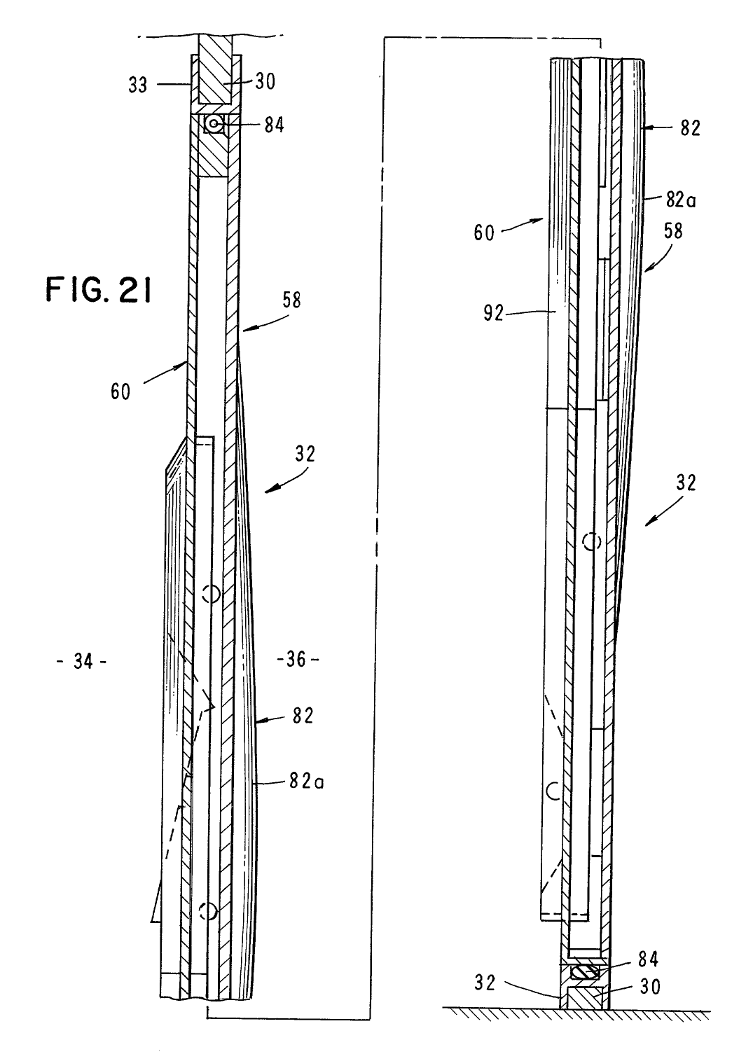

Turning now to FIGS. 4 through 21, one form of the security door assembly 32 of the invention is there shown. As previously mentioned, security door assembly 32 is hingedly connected to ridged steel frame 33 that, as previously mentioned, is securely mounted within security bulkhead 30 (FIG. 1). As best seen in FIGS. 10, 11 and 15, security door assembly 32 is movable between the closed position shown by the solid lines in FIG. 15 and the open position shown by the phantom lines in FIG. 15 and comprises a front assembly 58 and a rear assembly 60 that is sealably interconnected thereto (FIG. 4). As indicated in FIGS. 10 and 11, the front assembly 58 comprises a frame-like support 62 that is made up of interconnected top, bottom and side structural elements 64, 66, and 68 respectively to define an egress opening 80. Releasably mounted within egress opening 80 is a moveable member, here shown as a central panel 82 having a convex central portion 82a (see particularly FIGS. 4 and 5). The convex portion of the central panel, which is provided with a plurality a strategically located reinforcing ribs 83 (FIG. 11), protrudes into the passenger compartment so as to effectively resist blunt force entry.

As illustrated in FIGS. 4 and 5, the first and second, or front and rear assemblies 58 and 60 are sealably interconnected by a sealing means, here provided as a generally rectangular shaped gasket 84 that circumscribes the periphery of the cooperating front and rear assemblies. Gasket 84 sealably engages the inner surfaces of frame 33 so as to prevent passage of noxious and hazardous gases into the sensitive area from the second adjacent area.

Forming an important aspect of the first assembly 58 is restraint means for controllably restraining the movement of the movable portion, or central panel 82. The construction and operation of this important restraint means will presently be described.

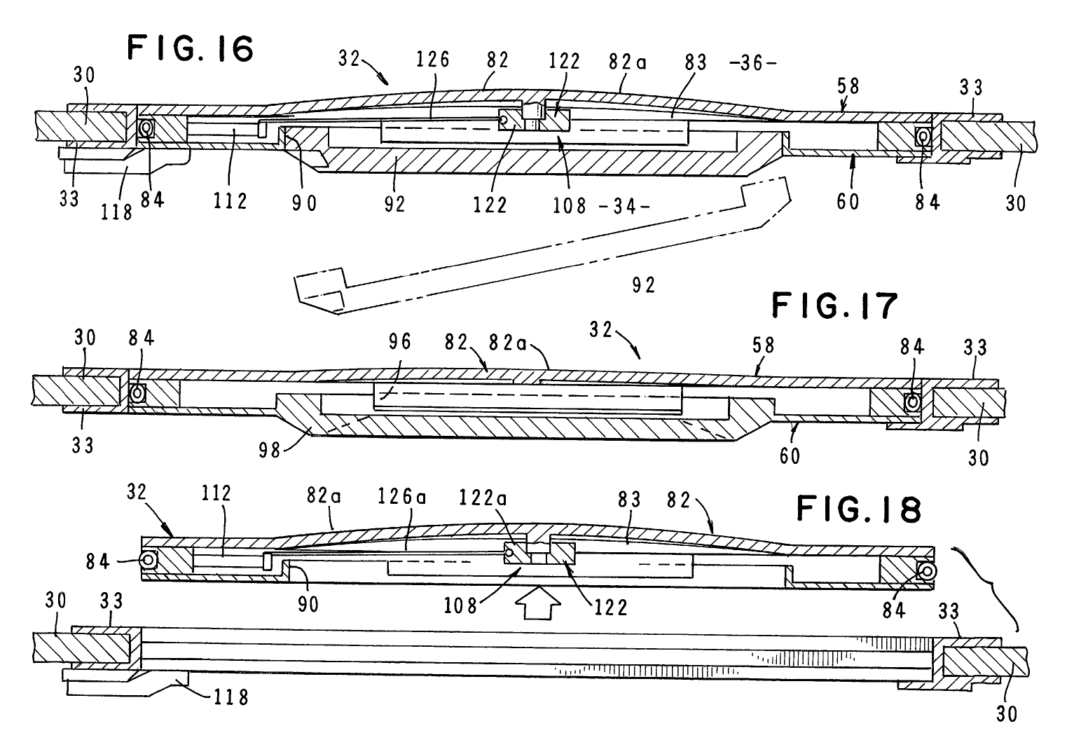

As best seen in FIG. 11, rear assembly 60 comprises a central portion 86 and a peripheral portion 88 that circumscribes central portion 86. Central portion 86 includes an emergency access opening 90 for gaining access to the restraint means that forms a part of first assembly 58. As will presently be described, access opening 90 enables the expeditious removal of central panel 82 of front assembly 58 in the manner shown in FIG. 18 of the drawings so as to permit emergency evacuation of the pilot's compartment. As shown in FIGS. 16 and 17, an access cover 92 is removably connected to central portion 86 of first assembly 60 and, when in place, functions to cover the emergency access opening 90. As well presently be described, access cover 92, the configuration of which is shown in FIG. 6, is removable from the central portion 86 in the manner illustrated by the phantom lines in FIG. 16.

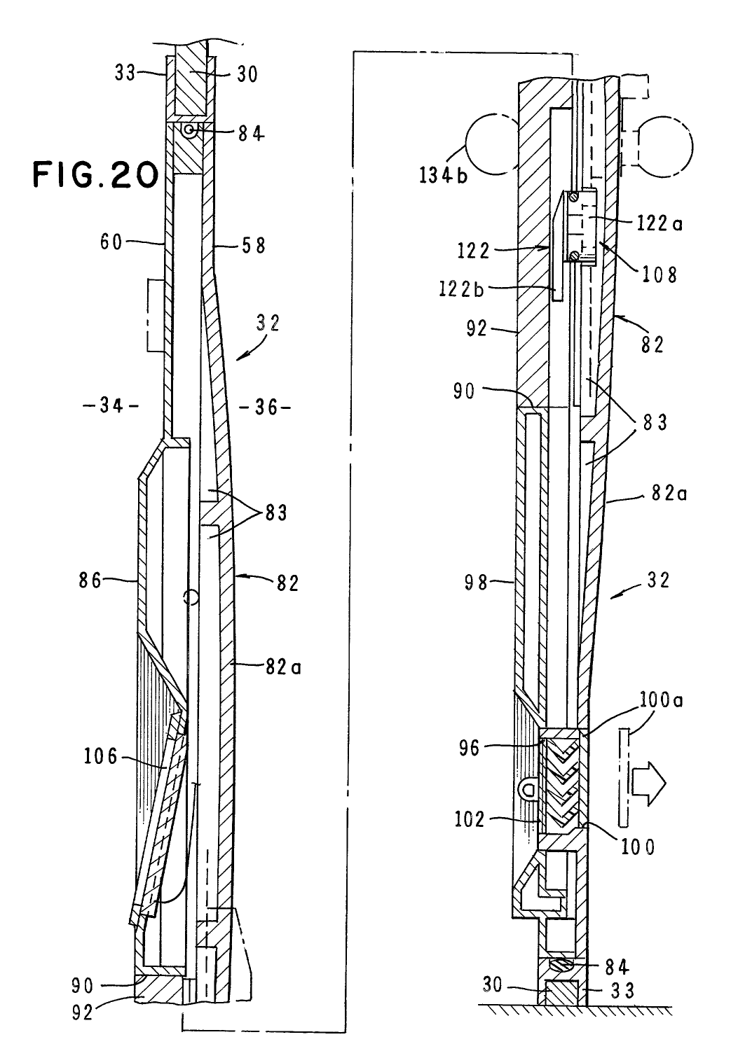

An important feature of the security barrier of the present form of the invention is a pressure equalization means that is carried by the security door for equalizing the pressure between the first sensitive area and the second adjacent area. This important pressure equalization means here comprises a louvered vent opening 96 that is provided within a lower panel 98 of rear assembly 60. Vent opening 96 communicates with a similarly sized, louvered vent opening 100 provided in the bottom structural member 66 of front assembly 58 to define an air passageway between the pilot's compartment and the passenger compartment. Vent opening 100, which is normally closed by a blowout panel 100a, also comprises a part of one form of the pressure equalization means of the present form of the invention (FIG. 10). As illustrated in FIG. 11, a frangible membrane 102, which also comprises a part of the pressure equalization means of the invention, is disposed within the air passageway intermediate vent openings 98 and 100 (see also FIG. 7). Frangible membrane 102, which comprises a thin sheet membrane having undercuts, is of a character well known to those skilled in the art that will automatically rupture should a differential pressure of a predetermined amount develop between the sensitive area, such as the pilot's compartment that is being protected and the second adjacent area, such as the passenger compartment (see also FIG. 20). However, so long as there is no accidental depressurization of either one of the areas 34 or 36, frangible membrane 102 will remain in tact and will prevent gas flow between the passenger compartment and the sensitive area thereby protecting the sensitive area from a release of a hazardous gas by a terrorist within the passenger compartment. However, should a depressurization occur, membrane will rupture causing panel 100a to be ejected into the passenger compartment and allowing the pressure to equalize between the two compartments.

Central portion 86 of rear assembly 60 also includes a viewing port or screen 106 that can be provided in the form of a conventional camera monitor. The viewing screen enables persons within the sensitive area to view the adjacent area via the viewing screen and a conventional fisheye viewing lens 106a mounted on the security door assembly (FIG. 9).

Turning particularly to FIGS. 11 and 13, one form of the restraint means of the invention is there shown and generally designated by the numeral 108. This restraint means here comprises a plurality of circumferentially spaced-apart locking pins 110, 112, and 114. Each of the locking pins is carried by carried by central panel 82 and is movable between a first extended or locked position shown in FIG. 11 and a second retracted position in which the central panel 82 can be removed from frame 62 in the manner illustrated in FIG. 18 of the drawings. More particularly, locking pin 110 is telescopically received within a hinge assembly 116 that is connected to a frame 33 in the manner shown in FIG. 13. Similarly, locking pin 112 is telescopically received within a lower hinge assembly 118 that is connected to frame 33 in the manner shown in FIG. 13. As indicated in FIG. 13, the third locking pin 114 is telescopically mounted within the door lock assembly, generally designated in FIG. 13 by the numeral 120.

The restraint means 108 of the present form of the invention also includes operating means that is carried by central panel 82 of front assembly 58 in a manner shown in FIGS. 11 and 13. As illustrated in these figure drawings, the operating means, which is generally designated by the 121, is operably associated with the spaced-apart locking pins 110, 112, and 114 and functions to move the locking pins from the locking position into the retracted position upon rotation of a handle member 122 that is mounted on central panel 82 in the manner shown in FIGS. 11 and 13. Handle assembly 122 includes a hub portion 122a and a handle portion 122b that is connected thereto. As best seen in FIG. 13 release pin 110 is interconnected with hub portion 122a by means of an elongated cable 124. Similarly, locking pin 112 is interconnected with hub portion 122a by an elongated cable 126.

In similar manner, locking pin 114 is interconnected with hub portion member 122a by an elongated cable 128. It is ape-parent that, with this construction, upon rotation of the hub member 118, using handle 118b, each of the locking pins will be moved into the retracted position shown in FIG. 13. With the pins in this retracted position, central panel 82 can be readily removed from frame 58 in the manner illustrated in FIG. 18.

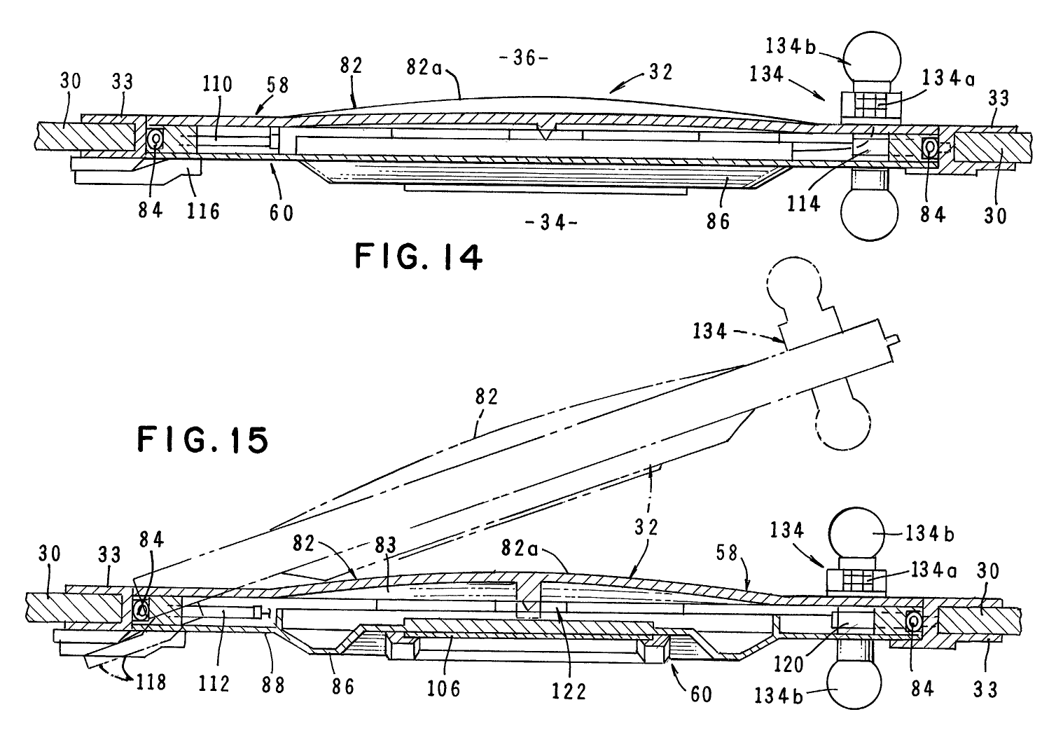

As best seen in FIGS. 14 and 15 the security door assembly of the invention includes specially constructed hinges 132 that are hingedly connected to frame 33 so that as the security door moves from the open position shown in the phantom lines in FIG. 15, to the closed position shown in FIG. 14, Gasket 84 will be compressed to provide a gas tight seal between the security door and frame 33. The security door assembly also includes a security door handle assembly, generally designated by the numeral 134, which operates the previously identified door lock assembly 120. The security door handle assembly includes a keyboard 134a that is of a conventional construction and is used to enable operation of the door lock assembly to gain access to the sensitive area. The doorknob portion 134b of the door handle assembly is constructed so that it will pull off upon the exertion of a pressure in excess of 90 pounds.

Mounted in the security door assembly is a second keyboard assembly 136 that is located proximate the previously mentioned “fisheye” type-viewing lens 106a.

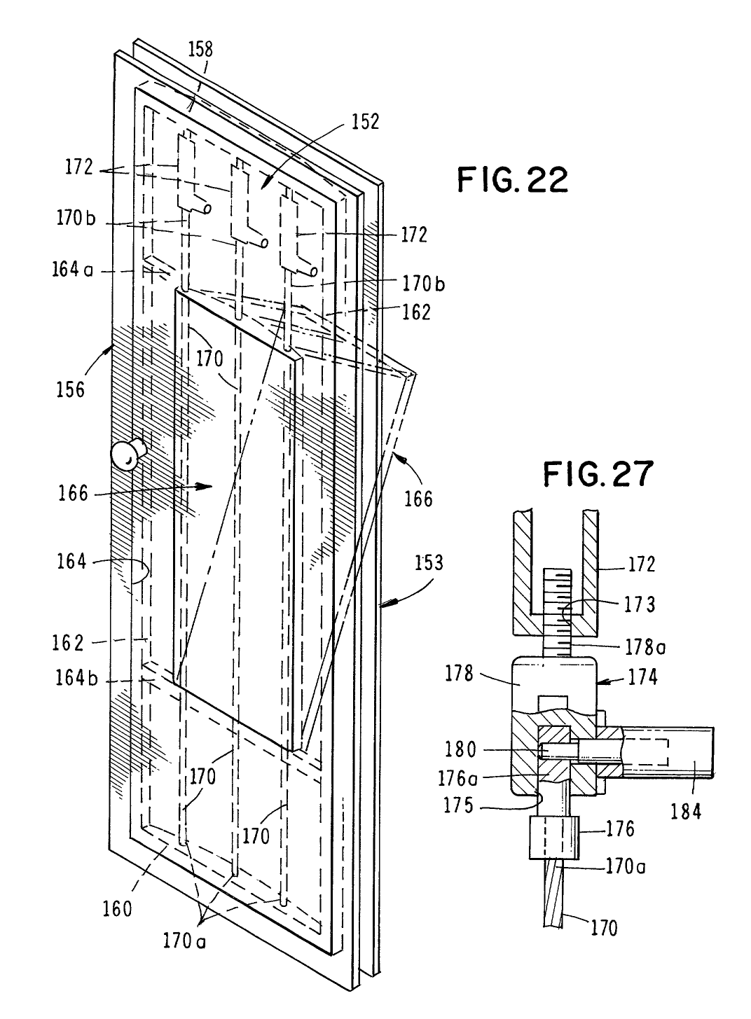

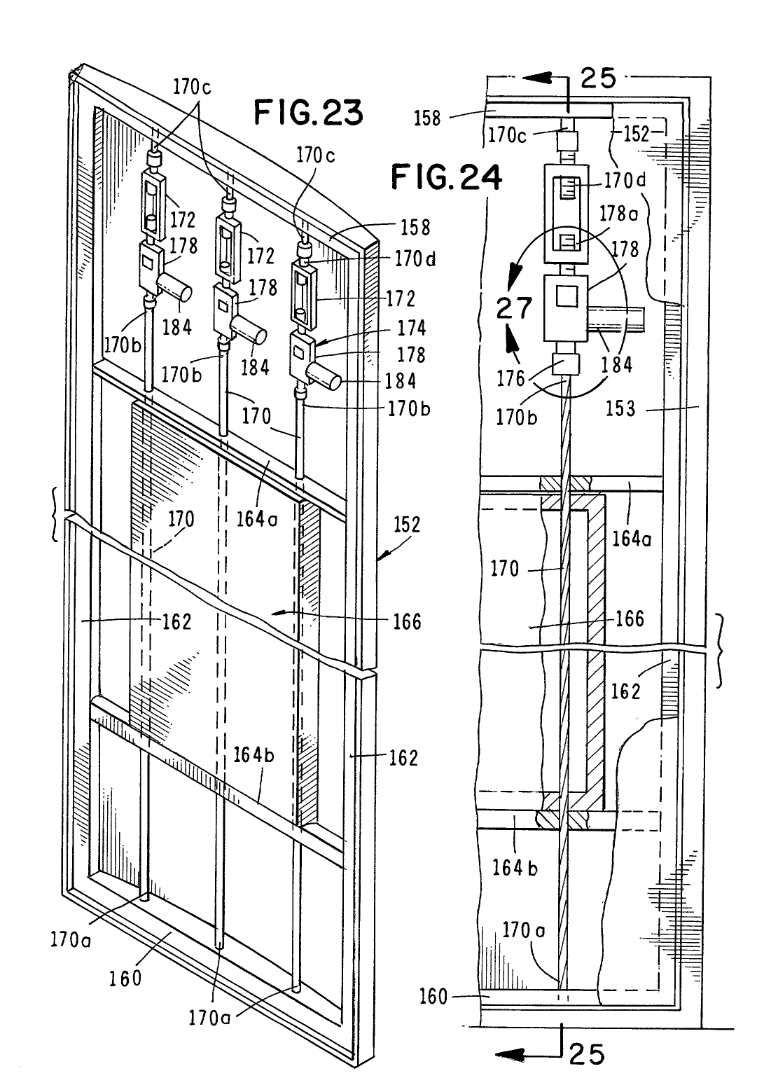

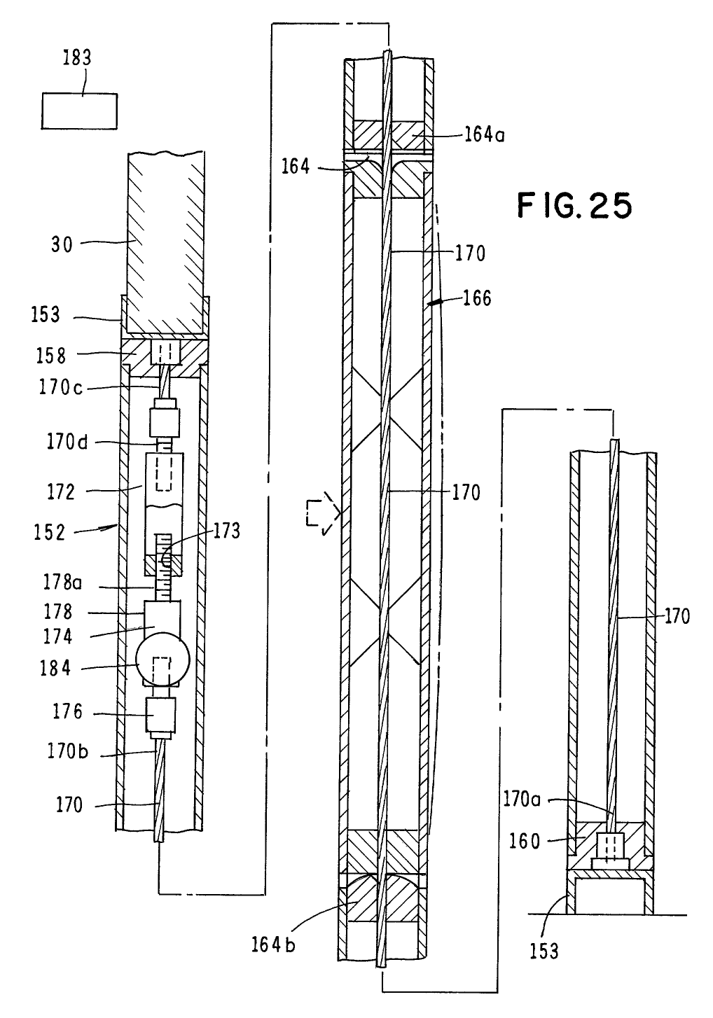

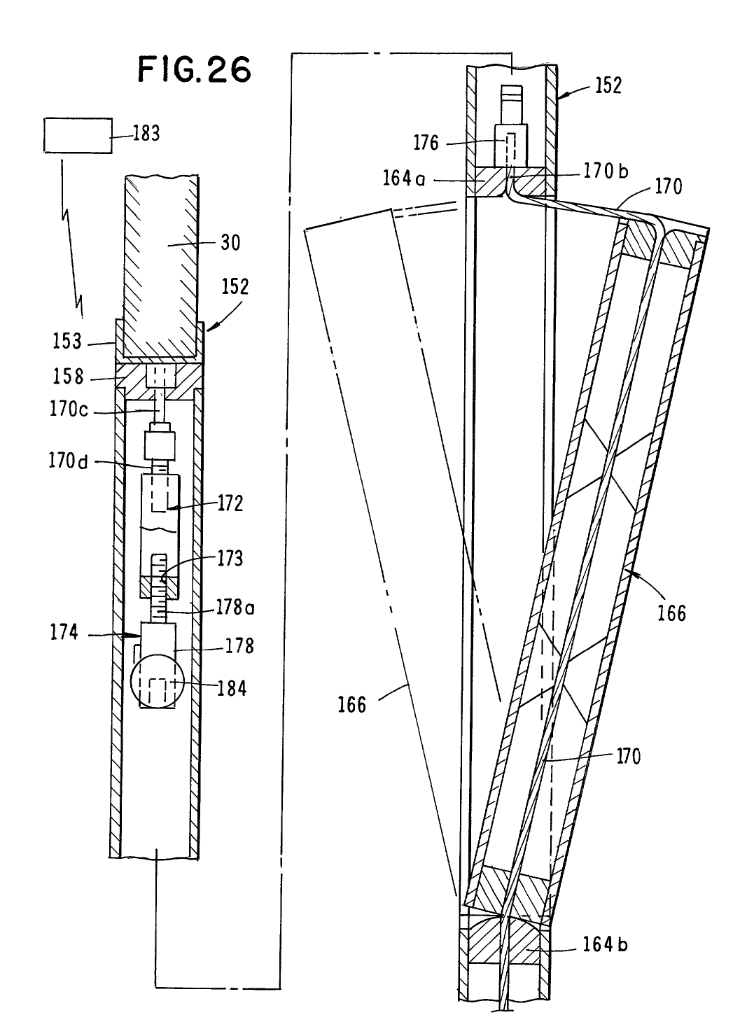

Referring to FIGS. 22 through 27, an alternate form of the security door assembly of the invention is there shown and generally designated by the numeral 152. As in the earlier described embodiment of the security door assembly, security door assembly 152 is hingedly connected to a rigid steel frame 153 that is securely mounted within security bulkhead 30 (FIGS. 1 and 26). The security door assembly is movable within frame 153 between a closed position and an open position and comprises a frame-like support 156 that is made up of interconnected top, bottom and side structural elements 158, 160 and 162 respectively. Releasably mounted within a central opening 164 formed in door 152 and defined by cross members 164a and 164b is a movable portion shown here as a central panel 166. In a manner presently to be described, upon depressurization of the passenger compartment, central panel 166 is movable from the closed position as shown by the solid lines in FIG. 22 into the open position shown by dotted lines in FIG. 22. Forming an important aspect of the security door assembly of the present invention is restraint means for controllably restraining the movement of the movable portion of the door assembly, here shown as central panel 166. As is best seen FIGS. 23 and 24, the restraint means of the present form of the invention comprises a plurality of elongated engagement members carried by the door assembly for engagement with panel 166. These engagement members are here shown as three lengths of cable 170, each of which has a first or lower end 170a and a second or upper end 170b. First end 170a of each of the cables is connected to frame member 160 of the door assembly while second end 170b of each of the cables is connected to connector means for releasably interconnecting the second end of each of the cables with upper frame member 158 of the door assembly. As best seen in FIGS. 23 and 25, each of the elongated cables 170 passes through the central panel 166 and cooperate to secure the panel in position within the assembly.

In the present form of the invention the connector means comprises a plurality of turnbuckle assemblies 172 that are connected to cables 170 for stretching the cables and a gripping means or gripping assembly 174 that is connected to each of the turnbuckle assemblies 172 for gripping the second end of each of the elongated cables 170 (see FIG. 27). Each of the turnbuckle assemblies 172 is interconnected with upper frame member 158 by means of a short length of cable 170c and a threaded connector rod 170b.

As best seen in FIG. 27, each of the gripping assemblies 174 comprises a cable connector 176 to which the second end 170b of one of the cables 170 is connected and a housing 178 that is provided with a threaded connector 178a that is threadably receivable within a threaded aperture 173 provided in the lower portion of one of the turnbuckles 172. Housing 178 is also provided with a bore 175 that is adapted to telescopically receive the stem portion 176a of the cable connector 176. Stem portion 176a of the cable connector is releasably connected to housing 178 by means of a connector pin 180 (FIG. 27). In a manner presently to be described, connector pin 180 is movable by the operating means of the invention, which also comprises a portion of the connector means, from the first cable connecting position shown in FIG. 27 to a second cable release position shown in FIG. 26. In the present form of the invention this important operating means comprises electronic means that is operably associated with the gripping means for moving the connector pin 180 of the gripping means between the first and second positions.

Operably associated with the electronic means of the invention is a sensor means, which here comprises a pressure sensing device 183 that is mounted proximate the door assembly 152 and is operably associated with said electronic means for operating the gripping means upon a depressurization of the passenger compartment. While various types of electronic means can be used to operate the gripping means, the electronic means is here provided in the form a conventional, electrically operated solenoid 184 that is operably associated with pin 180 for moving the pin between the first locked position shown in FIG. 27 and the second release position shown in FIG. 26.

In normal operation, the cables 170 pass through central panel 166 in the manner shown in FIG. 23 and are maintained in a tensioned condition by the turnbuckles 172. With the cables in this tensioned configuration, forces exerted on the panel 166 may cause the panel to move slightly within the door opening, but will positively prevent removal of the panel from the door opening. However, in the event of a loss of pressurization in the passenger compartment, the sensing device 84 will immediately sense the loss of pressure and will generate and transmit an electric signal to each of the solenoids 84 causing them to instantly retract the locking pins 180 from stem 176a. Once the pins have been moved into their release positions, the cable connectors 176 will separate from the housings 178 thereby permitting the panel 176 to move from the closed position shown in FIG. 25 to the open position shown in FIG. 26 so as to allow the pressure to equalize between the passenger compartment and the pilot's compartment. It is to be observed that, because the panel 166 rests on cross-member 164b and is free-floating within the central opening 164 provided in the door, the panel 166 can move either into the position indicated by the solid lines in FIG. 26 or alternatively into the position shown by the dotted lines in FIG. 26. When the pressure has been equalized between the passenger compartment in the pilot's compartment the central panel 166 can be repositioned within the central opening in the door and the cables 170 can be reconnected with the connector means in the manner shown in FIG. 27.

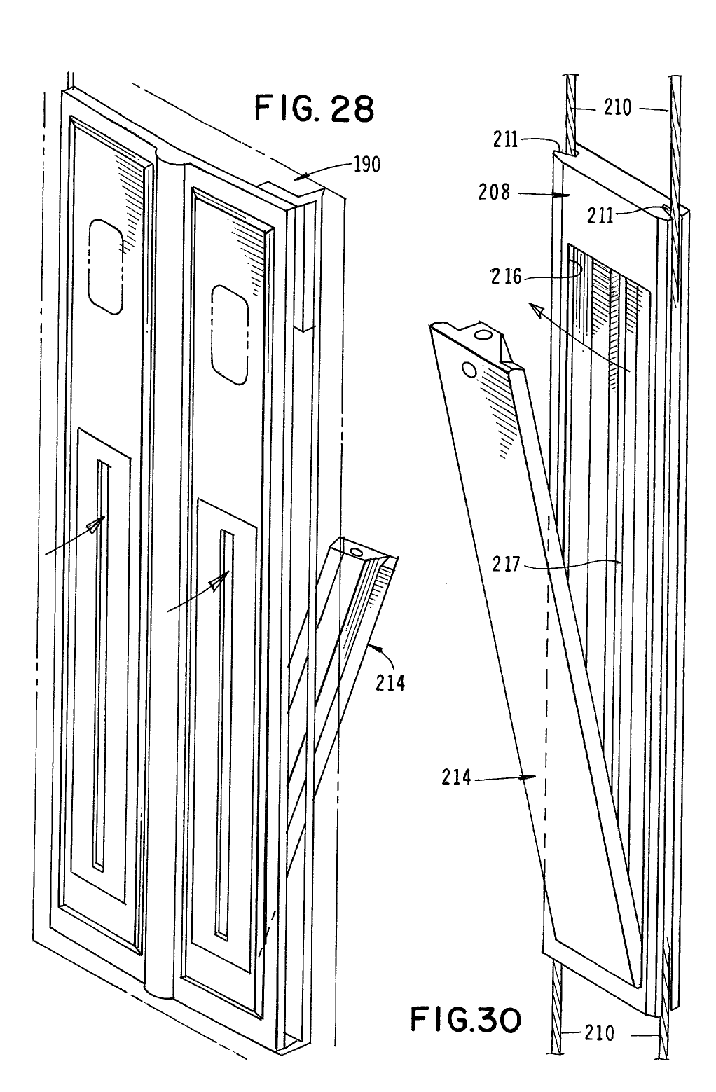

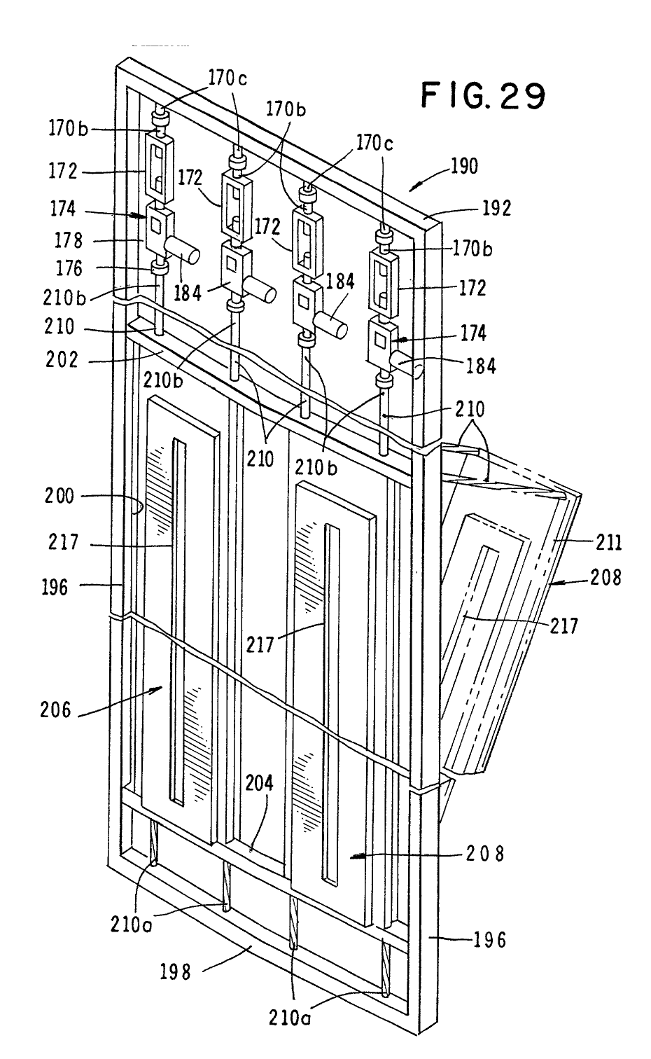

Referring to FIGS. 28 through 34, still another form of the security door assembly of the invention is there shown and generally designated by the numeral 190 (FIG. 29). This form of the security door assembly is similar in some respects to the earlier described security door assemblies and like numerals are used in FIGS. 28 through 31 to describe like components. As in the earlier described embodiments the security door assembly is hingedly connected to a rigid steel frame 153 that is securely mounted within security bulkhead 30 (FIG. 1). The security door assembly 190 is movable within frame 153 between a closed position and an open position and comprises a frame-like support 192 that is made up of interconnected top, bottom and side structural elements 194, 196 and 198 respectively (FIG. 29). Releasably mounted within a central opening 200 formed in door assembly 190 and defined by cross members 202 and 204 are movable portions shown here as a pair of central panels 206 and 208. In a manner presently to be described, upon depressurization of the passenger compartment, central panels 206 and 208 are movable from a closed position of shown by the solid lines in FIG. 29 into an open position shown by dotted lines in FIG. 29.

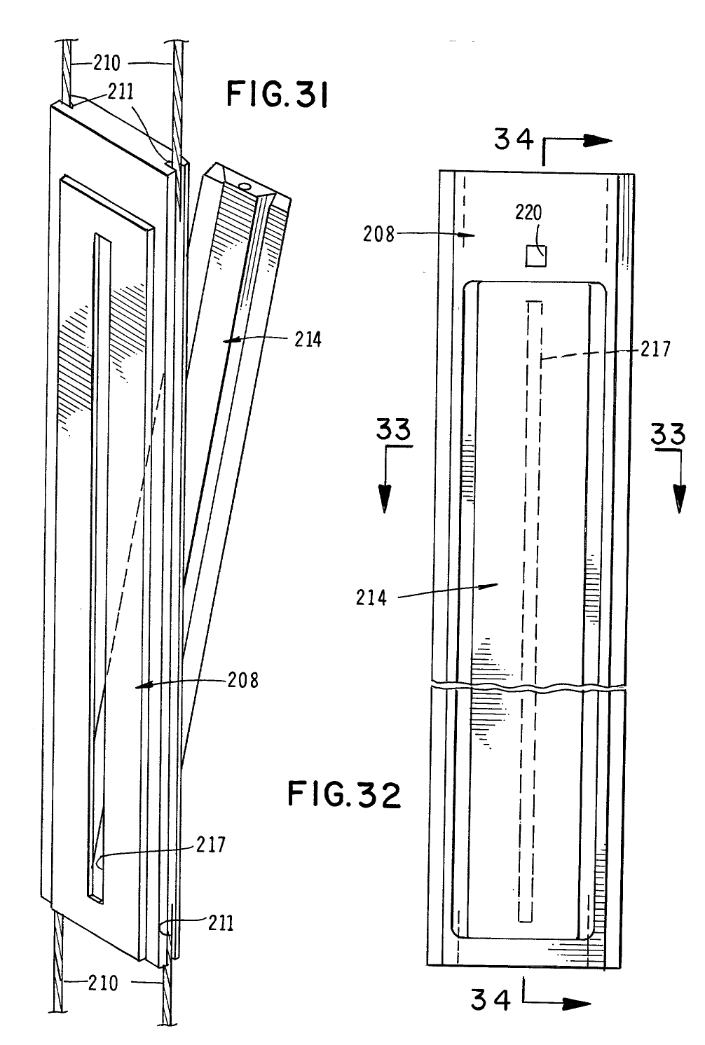

Forming an important aspect of the security door assembly of this latest form of the invention is restraint means for controllably restraining the movement of the central panels. This restraint means is quite similar to that previously described and comprises a plurality of elongated engagement members carried by the door assembly for engagement with panels 206 and 208. These engagement members are here shown as four lengths of cable 210, each of which has a first or lower end 210a and a second or upper end 210b. First end 210a of each of the cables is connected to frame member 198 of the door assembly while second end 210b of each of the cables is connected to connector means for releasably interconnecting the second end of each of the cables with upper frame member 194 of the door assembly. As indicated in FIGS. 30 and 31, each of the elongated cables 210 passes through and is restrained within channel shaped openings 211 formed in the edge portions of panels 206 and 208.

In this latest form of the invention the connector means comprises a plurality of turnbuckle assemblies 172 that are identical in construction and operation to those previously described. Each of the turnbuckle assemblies 172 is interconnected with upper frame member 194 by means of a short length of cable 170c and a threaded connector rod 170b (FIG. 29).

As before, gripping assemblies 174 interconnect cable ends 210b with the turnbuckles 172 in the manner shown in FIG. 27. As in the earlier described embodiment, a connector pin 180 is movable by the operating means of the invention from the first cable connecting position to a second cable release position to permit the panels 206 and 208 to move into an open position shown by the phantom lines in FIG. 29. As before, the operating means comprises electronic means that is operably associated with the gripping means for moving the connector pin 180 of the gripping means between the first and second positions.

Operably associated with the electronic means of the invention is a sensor means, or a pressure sensing device 183 that is identical in construction and operation to that previously described in connection with FIGS. 22 through 27. In normal operation, the cables 210 are constrained within channels 211 formed in the edges of panels 206 and 208 and are tensioned by turnbuckles 172. With the cables in this tensioned configuration, forces exerted on the panels 206 and 208 may cause the panel to move slightly within the door opening, but will positively prevent removal of the panels from the door opening. However, in the event of a loss of pressurization in the passenger compartment, the sensing device 183 will immediately sense the loss of pressure and will generate and transmit an electric signal to each of the solenoids 84 of the operating means which will cause the cable connectors 176 to separate from the housings 178 thereby permitting the panels 206 and 208 to move from the closed position shown by the solid lines in FIG. 29 to the open position shown by the phantom lines in FIG. 29. With the panels in the open position the pressure will equalize between the passenger compartment and the pilot's compartment. It is to be observed that, because the panels 166 rest on cross-member 204 and are free-floating within the central opening 200 provided in the door, the panels can move either forwardly or rearwardly. When the pressure has been equalized between the passenger compartment in the pilot's compartment the panels can be repositioned within the central opening in the door and the cables 210 can be reconnected with the connector means in the manner shown in FIG. 29.

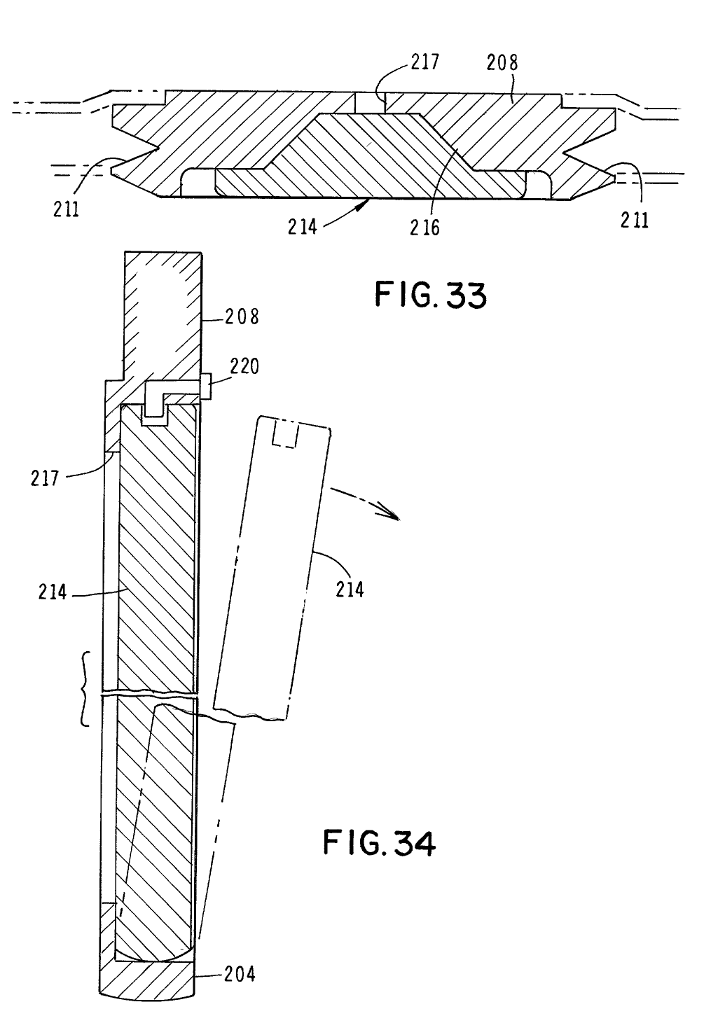

A highly novel feature of this latest form of the invention resides in the provision of vent means within each of the panels 206 and 210 for providing an air passageway between the passenger and pilot's compartments. As best seen by referring to FIGS. 30, 31 and 33, this important vent means here comprises a sub-panel 214 that is sealably received within an elongated cavity 216 formed in each of the panels 206 and 208. More particularly, a subpanel 214 is hingedly connected to each of the panels 206 and 208 for movement between a sealing position wherein the sub-panel resides within the elongated cavity 216 (see FIG. 33) and a venting position wherein the sub-panel resides in the angularly extending, open position such as is shown and FIGS. 30 and 31. As best seen by referring to FIGS. 28, 32, and 33 each of the panels 206 and 208 is provided with the elongated, slit-like opening 217 that is sealed when the sub-panel 214 is disposed within a cavity 216, but provides an air passageway between the pilot's compartment and the passenger compartment when the sub-panel is swung into the open position shown in FIGS. 30 and 31.

The venting sub-panels 214 are held in position within cavities 216 by a manually operated locking arm 220 (FIG. 34). The locking arm 220 can readily be rotated by the pilot into an unlocked position which allows the sub-panel to be pulled inwardly of the pilot's compartment in the manner indicated by the phantom lines in FIG. 34. When the sub-panels in the open configuration, air can freely flow between the pilot's compartment and the passenger compartment via slit-like openings 217

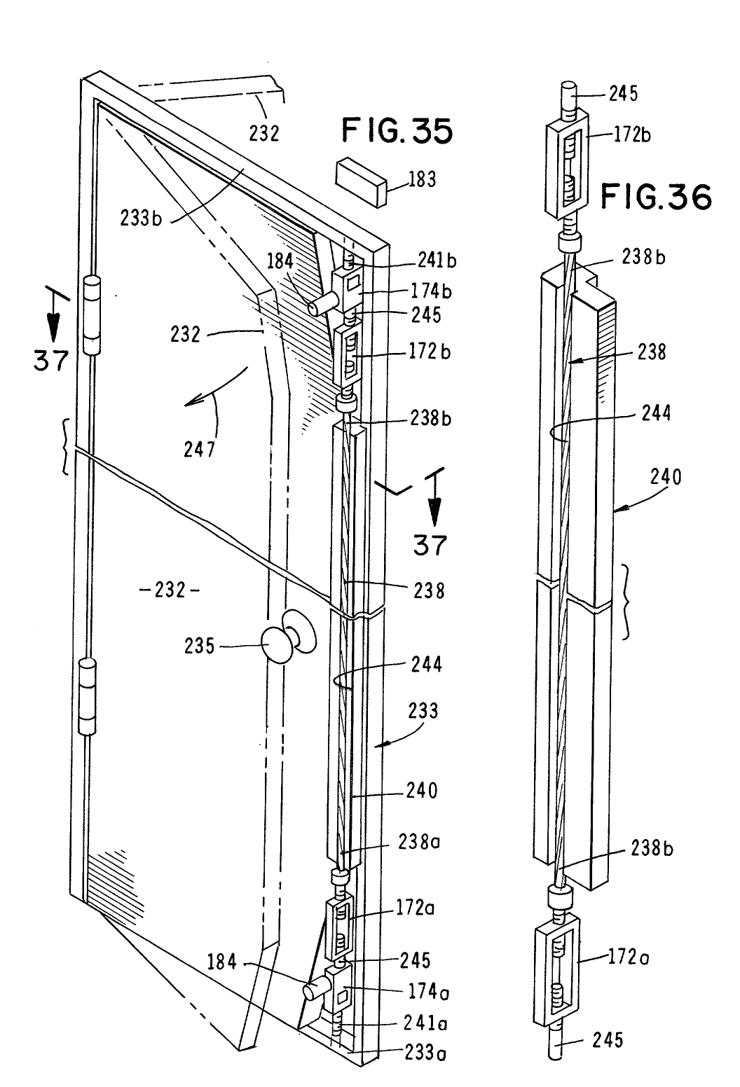

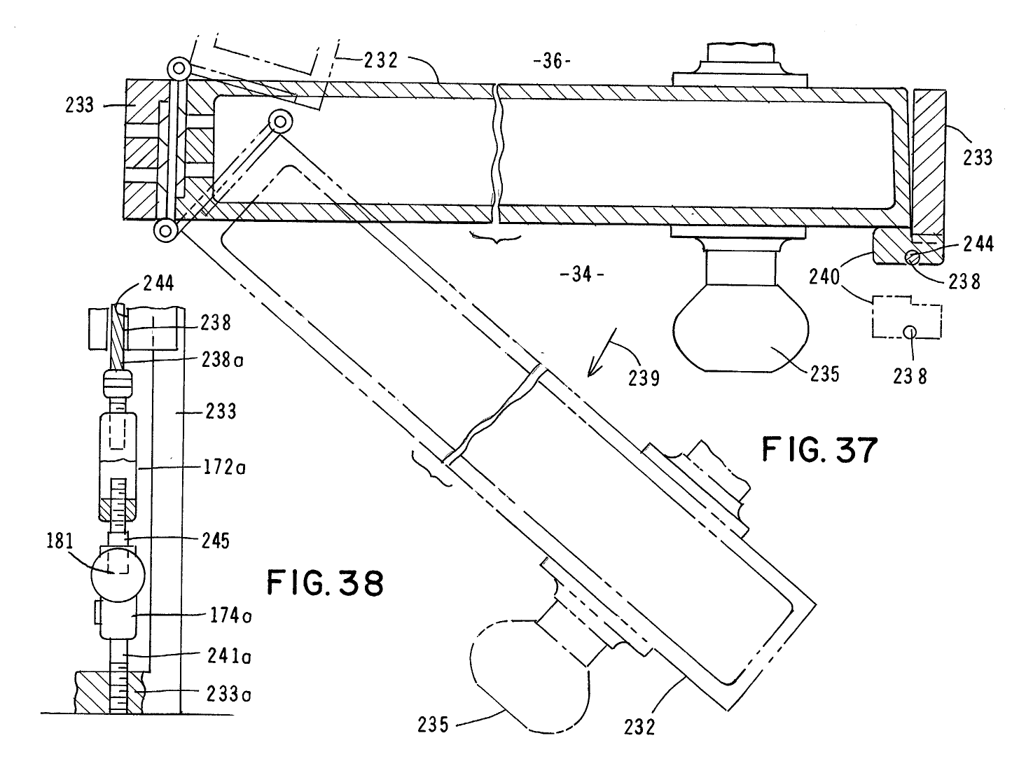

Referring next to FIGS. 35 through 38, still another form of the security door assembly of the invention is there shown and generally designated by the numeral 230. This form of the security door assembly is similar in some respects to the earlier described security door assemblies and like numerals are used in FIGS. 35 through 38 to describe like components. In this latest embodiment of the invention, the security door 232 of the security door assembly is hingedly connected to a rigid steel frame 233 that is securely mounted within security bulkhead (see for example FIG. 1). The security door 232 is movable within frame 233 between a closed position shown by the solid lines in FIG. 37 and an open position, that is into the passenger compartment, as shown by the phantom lines in the upper left portion of FIG. 37. For this purpose the door assembly is provided with a conventional door handle assembly 235. Releasably mounted within frame 233 is the restraint means of this latest form of the invention for controllably restraining the movement of the door 232 into the pilot's compartment as shown by the phantom lines located in the lower portion of FIG. 37. This restraint means is similar in some respects to that previously described and comprises an elongated engagement member, or cable 238 carried by the frame 233 for engagement with an elongated door stop 240 that comprises a movable member and forms a part of the restraint means of the invention. As indicated in FIG. 37, door stop 240 normally functions to prevent the door from swinging into the pilot's compartment in the direction of the arrow 239 of FIG. 37. Cable 238 has a first or lower end 238a and a second or upper end 238b. First end 238a of the cable is connected to a lower connector means, which, in turn, is connected to the lower frame member 233a of the door frame, while second end 210b of the cable is connected to an upper connector means, which, in turn, is connected to the upper frame member 233b of the door frame. As indicated in FIGS. 35 and 36, elongated cable 238 passes through and is restrained within a channel shaped opening 244 formed in the face of the door stop 240.

In this latest form of the invention each of the upper and lower connector means comprises a turnbuckle assembly 172 that is identical in construction and operation to those previously described. Lower turnbuckle assembly 172a is interconnected with lower frame member 233a by means of a lower gripping assembly 174a and a threaded stud 241a, while upper turnbuckle assembly 172b is interconnected with upper frame member 233b by means of an upper gripping assembly 174b and a threaded stud 241b. Gripping assemblies 174a and 174b are similar in construction and operation to the earlier described gripping assemblies 174 save for the fact that instead of gripping connectors such as connectors 176 (FIG. 27), the gripping assemblies releasably grip threaded connector studs 245 that function to connect the gripping assemblies with turnbuckles 172a and 172b (see FIGS. 35 and 38).

As in the earlier described embodiments, a connector pin is movable by the operating means of the invention from the first connecting position to a second release position to permit the door stop 240 along with the cable and the turnbuckles to fall free of the door frame 233 thereby permitting the security door 232 to swing into an open position in the direction of the arrow 247 of FIG. 35 upon an accidental depressurization of the pilot's compartment. As before, the operating means comprises electronic means that is operably associated with the gripping means for moving the connector pin of the gripping means between the first and second positions to permit the turnbuckles, the cable 238 and the door stop 240 to separate from the door frame 233.

Operably associated with the electronic means of the invention is a sensor means, or a pressure sensing device 183 that is identical in construction and operation to that previously described in connection with FIGS. 22 through 27.

In normal operation, cable 238 is constrained within channel 244 formed in door stop 240 and is tensioned by turnbuckles 172a and 172b. With the cables in this tensioned configuration, intrusive forces exerted on the door 232 may cause the door to move slightly within the doorframe, but the cable and the door stop will cooperate to positively prevent the door from opening. However, in the event of a loss of pressure in the pilot's compartment, the sensing device 183 will immediately sense the loss of pressure and will generate and transmit an electric signal to each of the solenoids 84 of the operating means which will cause the cable connectors 174a and 174b to separate from the turnbuckles thereby permitting the door stop 240 to fall away from the door frame 233. With the door stop separated from the door frame in the manner shown by the phantom lines in FIG. 37, the door 232 is free to move from the closed position shown by the solid lines in FIG. 35 to the open position shown by the phantom lines in the lower portion of FIG. 35 so as to allow the pressure to equalize between the passenger compartment and the pilot's compartment. When the pressure has been equalized between the passenger compartment and the pilot's compartment, the door stop 240 can be repositioned within the door frame and the cable 238 can be reconnected with the connector means in the manner shown in FIG. 35.

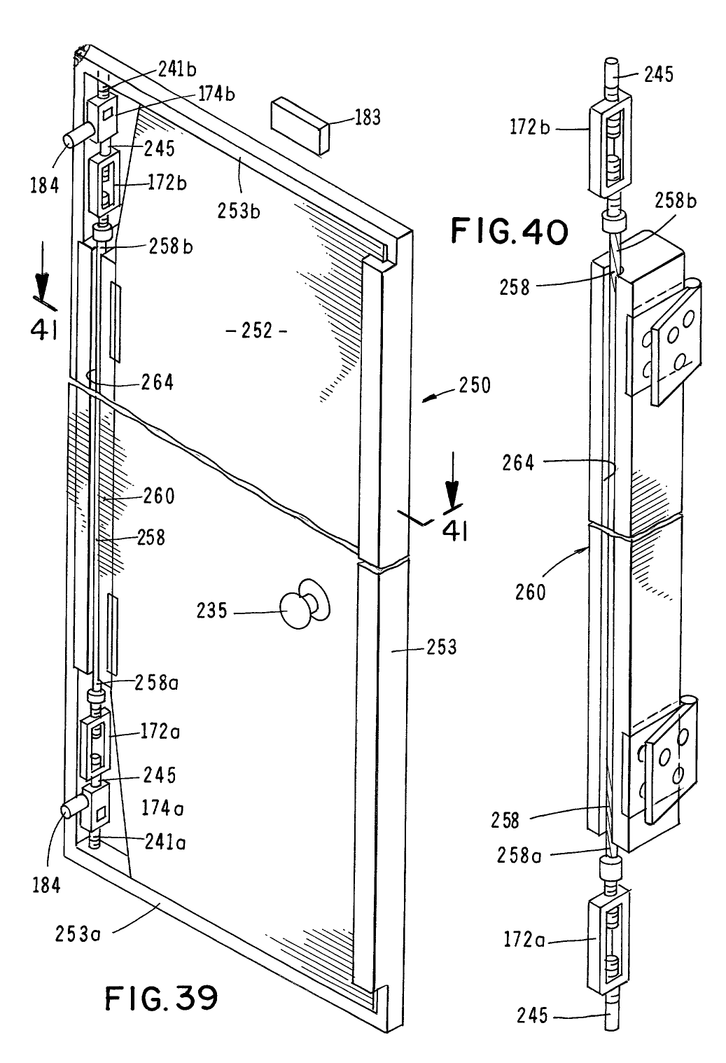

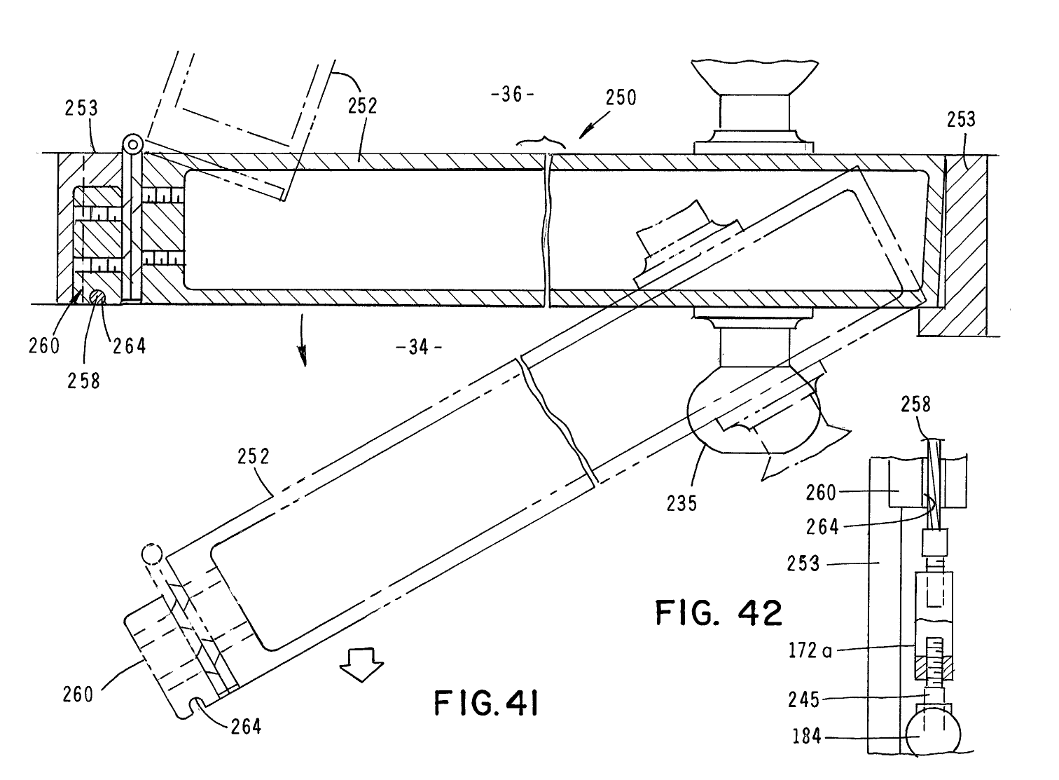

Referring finally to FIGS. 39 through 42, yet another form of the security door assembly of the invention is there shown and generally designated by the numeral 250. This form of the security door assembly is also similar in some respects to the earlier described security door assemblies and like numerals are used in FIGS. 39 through 42 to describe like components. In this latest embodiment of the invention, the security door 252 of the security door assembly is hingedly connected to a rigid steel frame 253 that is securely mounted within security bulkhead (see for example FIG. 1). The security door 252 is movable within frame 253 between a closed position shown by the solid lines in FIG. 41 and an open position, that is into the passenger compartment as shown by the phantom lines in the upper left portion of FIG. 41. For this purpose the door assembly is provided with a conventional door handle assembly 235. Releasably mounted within frame 233 is the restraint means of this latest form of the invention for controllably restraining the movement of the movable member, or door 252 into the pilot's compartment as shown by the phantom lines located in the lower portion of FIG. 41. This restraint means is similar in some respects to that previously described and comprises an elongated engagement member, or cable 258 carried by the frame 253 for engagement with a door hinge assembly 260 that also forms a part of the restraint means of the invention. As indicated in FIG. 41, door hinge assembly 260 normally functions to permit the door to swing open into the passenger compartment in the manner shown by the phantom lines in the upper left-hand portion of FIG. 41, but prevents the door from swinging into the pilot's compartment in the direction of the arrow of FIG. 41. Cable 258 has a first or lower end 258a and a second or upper end 238b. First end 238a of the cable is connected to a lower connector means, which, in turn, is connected to the lower frame member 253a of the door frame, while second end 210b of the cable is connected to an upper connector means, which, in turn, is connected to the upper frame member 233b of the door frame. As indicated in FIGS. 39 and 40, elongated cable 258 passes through and is restrained within a channel shaped opening 264 formed in door hinge assembly 260.

In this latest form of the invention, each of the upper and lower connector means comprises a turnbuckle assembly 172 that is similar in construction and operation to those previously described. Lower turnbuckle assembly 172a is interconnected with lower frame member 253a by means of a lower gripping assembly 174a and a threaded stud 241a, while upper turnbuckle assembly 172b is interconnected with upper frame member 253b by means of an upper gripping assembly 174b and a threaded stud 241b. Gripping assemblies 174a and 174b are similar in construction and operation to the earlier described gripping assemblies 174 save for the fact that instead of gripping connectors such as connectors 176 (FIG. 27), the gripping assemblies releasably grip threaded connector studs 245 that function to connect the gripping assemblies with turnbuckles 172a and 172b (see FIGS. 39 and 42).

As in the earlier described embodiments, a connector pin is movable by the operating means of the invention from the first connecting position to a second release position to permit the door hinge assembly 260, along with the cable and the turnbuckles to fall free of the door frame 253 thereby permitting the security door 252 to move into an open position in the direction of the arrow of FIG. 41 upon an accidental depressurization of the pilot's compartment. As before, the operating means comprises electronic means that is operably associated with the gripping means for moving the connector pin of the gripping means between the first and second positions to permit the turnbuckles, the cable 238 and the door hinge assembly 260 to separate from the door frame 253.

Operably associated with the electronic means of the invention is a sensor means, or a pressure-sensing device 183 that is identical in construction and operation to that previously described.

In normal operation, cable 258 is constrained within channel 264 formed in door hinge assembly 260 and is tensioned by turnbuckles 172a and 172b. With the cables in this tensioned configuration, intrusive forces exerted on the door 252 may cause the door to move slightly within the doorframe, but the cables in cooperation with the door hinge assembly will positively prevent the door from opening. However, in the event of a loss of pressure in the pilot's compartment, the sensing device 183 will immediately sense the loss of pressure and will generate and transmit an electric signal to each of the solenoids 84 of the operating means which will cause the cable connectors 174a and 174b to separate from the turnbuckles thereby permitting the door hinge assembly 260 to fall away from the door frame 253. With the door hinge assembly separated from the door frame, the door 252 is free to move from the closed position shown by the solid lines in FIG. 42 to the open position shown by the phantom lines in the lower portion of FIG. 42 so as to allow the pressure to equalize between the passenger compartment and the pilot's compartment. When the pressure has been equalized between the passenger compartment and the pilot's compartment, the door hinge assembly 260 can be repositioned within the door frame and the cable 258 can be reconnected with the connector means in the manner shown in FIG. 39.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A security barrier for preventing unauthorized access to a first sensitive area from a second adjacent area comprising:
(a) a security bulkhead disposed between the first sensitive area and the second adjacent area;
(b) a frame a mounted within said bulkhead;
(c) a security door assembly hingedly connected to said frame for movement between an open position and a closed position, said security door assembly comprising:
(i) a movable portion movable between first and second positions; and
(ii) restraint means operably associated with said movable portion for controllably restraining movement of said movable portion, said restraint means comprising an elongated cable; and
(iii) operating means operably associated with said restraint means for operating said restraint means.

2. The security barrier as defined in claim 1 in which said security door assembly comprises a security door including:
(a) a central portion and a peripheral portion circumscribing said central portion, said central portion having an emergency access opening for gaining access to said restraint means; and
(b) an access cover removably connected to said central portion, said access cover being removable from said central portion to permit access to said restraint means.

3. The security barrier as defined in claim 1 in which in which said security door assembly comprises a security door having vent means for providing an air passageway between the first sensitive area and the second adjacent area.

4. The security barrier as defined in claim 1 in which said restraint means comprises:
(a) a plurality of circumferentially spaced apart locking pins carried by said movable portion for movement between a first locking position and a second retracted position;
(b) a hub portion rotatably carried by said movable portion; and
(c) a plurality of cables interconnecting said hub with said locking pins.

5. The security barrier as defined in claim 1 in which said restraint means comprises:
(a) a plurality of cables carried by said door assembly for engagement with said movable portion of said door assembly, each of said cables having a first end connected to said door assembly and a second end; and
(b) connector means carried by said door assembly for releasable interconnection with said second end of each of said cables.

6. The security barrier as defined in claim 1 in which said security door assembly further includes pressure equalizing means for equalizing the pressure between said first sensitive area and said second adjacent area.

7. The security barrier as defined in claim 1 in which said security bulkhead comprises a plurality of sealably interconnected segments, each said segment comprising:
(a) a steel layer;
(b) a first nonmetallic, composition layer disposed adjacent said steel layer;
(c) a second nonmetallic, composition layer spaced apart from said first nonmetallic, composition layer; and
(d) an aramid fiber composition layer disposed intermediate said first and second nonmetallic, composition layers.

8. The security barrier as defined in claim 7 in which each of said first and second nonmetallic, composition layers comprise fiberglass.

9. The security barrier at as defined in claim 7 in which said movable portion of said security door includes a generally convex surface extending into said first area.

10. The security barrier as defined in claim 7, further including sealing means carried by said security door for sealing said security door assembly relative to said frame.

11. The security barrier as defined in claim 10 in which said security door includes a vent opening providing an air passageway between said first sensitive area and said second adjacent area.

12. The security barrier as defined in claim 11, further including a frangible membrane disposed within said air passageway.

13. In combination with a bulkhead disposed between a pressurized passenger compartment and pilot's compartment, a security door assembly comprising a frame a mounted within said bulkhead and a security door hingedly connected to said frame, said security door assembly comprising:
(a) a movable portion movable from a first position to a second position upon a depressurization of the passenger compartment;
(b) restraint means operably associated with said movable portion for controllably restraining the movement of said movable portion of the door assembly, said restraint means comprising:
(i) at least one elongated engagement member carried by said door assembly for engagement with said movable portion of said door assembly, said engagement member having a first end connected to said door assembly and a second end; and
(ii) connector means carried by said door assembly for releasable interconnection with said second end of said engagement member;
(c) operating means operably associated with said restraint means for operating said restraint means to release said second end of said engagement member from said connector means; and
(d) sensor means carried by one of said bulkhead and said door assembly for sensing pressure within the passenger compartment, said sensor means being operably associated with said operating means for operating said operating means upon sensing a depressurization of the pressure compartment.

14. The combination as defined in claim 13 in which said engagement member comprises an elongated cable.

15. The combination as defined in claim 14 in which said connector means comprises:
(a) a turnbuckle connected to said cable for stretching said cable; and
(b) gripping means connected to said turnbuckle for releasable interconnection with said second end of said elongated cable, said gripping means being movable from a first interconnection position to a second cable release position.

16. The combination as defined in claim 15 in which said operating means comprises electronic means operably associated with said gripping means for moving said gripping means between said first and second positions.

17. The combination as defined in claim 16 in which said sensor means comprises a pressure sensing device carried by one of said door assembly and said bulkhead and being operably associated with said electronic means for operating said electronic means upon a depressurization of the passenger compartment.

18. In combination with a bulkhead disposed between a pressurized passenger compartment and pilot's compartment, a security door assembly comprising a frame a mounted within said bulkhead and a security door hingedly connected to said frame, said security door comprising:
(a) a movable portion movable from a first position to a second position upon a depressurization of the passenger compartment;
(b) restraint means operably associated with said movable portion for controllably restraining the movement of said movable portion of the door assembly, said restraint means comprising:
(i) at least one elongated cable carried by said door assembly for engagement with said movable portion of said door assembly, said cable having a first end connected to said door assembly and a second end;
(ii) connector means carried by said door assembly for releasably interconnecting said cable with said frame; and
(iii) operating means carried by said door assembly and operably associated with said connector means for operating said connector means to release said cable from said frame; and
(iv) sensor means carried by one of said door assembly and said bulkhead for sensing pressure within one of the passenger compartments and the pilot's compartment, said sensor means being operably associated with said operating means for operating said operating means upon sensing a change of pressure between the passenger compartment and the pilot's compartment.

19. The combination as defined in claim 18 in which said movable portion comprises a doorstop assembly affixed to said frame.

20. The combination as defined in claim 18 in which said movable portion comprises a door hinge assembly.

21. The combination as defined in claim 18 in which said operating means comprises a solenoid operably associated with said sensor means.

22. The combination as defined in claim 18 in which said movable portion comprises a sub-panel mounted within said door, said sub-panel including vent means for permitting the passage of air between said passenger compartment and said pilot's compartment.
